(19) United States
(12) Patent Application Publication
(10) Pub. No.: US 2008/0292460 A1
(43) Pub. Date: Nov. 27, 2008

(54) Fluid Turbine With Fluid-Tiltable Blades

(75) Inventors: Wen-Chung Kuo, Yonghe (TW); Ting-Hao Hsiao, Lujhou (TW); Yu-Lan Chao, Yonghe (TW); Chia-Nan Hu, Taipei (TW); Mark William Griffin, Taipei (TW)

Correspondence Address: HAYNES AND BOONE, LLP, 901 Main Street, Suite 3100, Dallas, TX, 75202, US

(73) Assignee: Seven Stars Worldwide Limited, Tortola (VG)

(21) Appl. No.: 12/123,806

(22) Filed: May 20, 2008

Related U.S. Application Data
(63) Continuation-in-part of application No. 11/768,206, filed on Jun. 26, 2007.

(30) Foreign Application Priority Data
May 21, 2007 (TW) 096117953

(51) Int. Cl. F03D 3/06; F03D 11/00

(52) U.S. Cl. 416/140

(57) ABSTRACT

A fluid-driven turbine includes a main driving shaft defining a shaft axis and a plurality of blade sets symmetrically disposed about the main driving shaft. Each of the plurality of blade sets includes a rod extending radially from the main driving shaft in a direction transverse to the shaft axis. The rod defines a rod axis. Each blade set also includes a fluid-tiltable blade connected to the rod and extending along the direction of the rod axis. It has an airfoil shape in cross-section with a leading edge, a trailing edge, and a maximum thickness. The blade is divided into first and second moment-inducing sections located on opposite sides of the rod with the first moment-inducing section being greater in area than the second moment-inducing section. Also, it is rotatable about the rod axis between an optimum pressure-receiving position and a least fluid-resistance position for receiving fluid energy from variable directions. The blade sets also include a stopper system limiting rotation of the blade about the rod axis to a rotation range between the optimum pressure-receiving position and a least fluid-resistance position.

### PRIORITY CLAIM

This application is a continuation-in-part application of U.S. patent application Ser. No. 11/768,206, filed Jun. 26, 2007, titled Vertical Axis Windmill with Wingletted Air-Tiltable Blades, incorporated herein in its entirety by reference. This application also claims foreign priority to Taiwanese application No. 096117953, filed May 21, 2007.

### TECHNICAL FIELD

This invention relates in general to a fluid turbine with tiltable blades, and in particular to a fluid turbine that employs aerodynamic force to tilt or swivel the angle of the blades such that the blades are automatically set in a windward position to receive fluid energy from variable directions so as to cause a shaft to drive a power generator.

### BACKGROUND

Due to the increasing consumption of fossil fuel, reserves of fossil fuel are gradually getting depleted and increasing levels of carbon dioxide are causing a severe “greenhouse” phenomenon in the Earth's atmosphere. Thus, the United Nations has issued regulations and commands and is coordinating the fight against global warming. Recently, all nations around the world have put a lot of effort into developing renewable energies, among which wind energy is one of the best. This is simply because wind power stations do not generate any carbon dioxide emissions and have absolutely no risk of nuclear pollution.

Electrical power is considered “advanced” energy and has an extremely wide range of applications. Electricity is also the foundation of modern civilization, and is a must for modern society.

The known horizontal axis wind power station usually needs a tower as high as 50 meters, which carries a generator and a blade assembly that drives the generator at the top thereof. This makes the tower very bulky, costly and difficult to maintain. Thus, the known construction of the horizontal axis windmill is apparently not an ideal solution for wind power stations.

Prior references discussing or disclosing windmill power generation include, for example, U.S. Pat. Nos. 4,496,283; 384,232; 440,266; 505,736; 685,744; 830,917; 1,076,713; 4,534,703; 4,679,985; 4,818,180; 5256,034; 4,220,870; 7,118,344; 6,749,399; 963,359; 5,269,647; 6,000,907; 6,537,018; 5,083,902; 6,749,393; 863,715; 4,509,899; 4,421,458; 6,726,439; 5,195,871; and 4,245,958, but are not limited thereto. These known references share at least the following drawbacks:

1. The construction is complicated and assembly is difficult, both leading to increased costs;

2. Swiveling or tilting of the blades to face the direction of the incoming airflow is not carried out by aerodynamic force, so an additional device for swiveling or tilting the blades is needed, such as a wind vane coupled to the blades by a transmission mechanism; and

3. The design of the structure is poor because a huge initial driving force is needed to swivel the blades to face the wind direction, such that the blade cannot be properly swiveled in low wind speed conditions, leading to low power generation efficiency.

Other prior references are also known, including U.S. Pat. Nos. 3,995,170; 6,688,842; and 6,749,394, none of which discloses effective use of the aerodynamic force, and all having the following drawbacks:

1. All the blades are individually arranged in a vertical state, and are not interconnected to facilitate swiveling thereof (the blades of U.S. Pat. No. 3,995,170 are interconnected, but a transmission mechanism is needed for the interconnection), so that the initial driving force for swiveling the blades is huge;

2. The blades have to be swiveled (by an angle of as much as 180 degrees) to face the wind direction by a huge initial driving force so that the blades cannot be swiveled in low wind speed conditions, leading to poor power generation efficiency; and

3. The blades are not of a design or construction good enough to facilitate swiveling of the blades with a small initial driving force.

Further prior references, such as U.S. Pat. No. 4,383,801, use a large wind vane to facilitate swiveling of blade via a cam. This known device has at least the following drawbacks:

1. The construction is complicated and assembly is difficult, both leading to an increase of costs; and

2. The swiveling of the blades is driven by mechanical transmission, so that the initial driving force for swiveling the blades is huge and the blades cannot be swiveled in low wind speed conditions, leading to poor power generation efficiency.

Further references, such as Chinese Patent No. 96120092.8, disclose a blade swiveling system that uses a wind vane to track the wind direction and issue an electronic signal to control a servo motor which swivels the blades, but the blades have to be driven all the way by the servo motor, leading to consumption of electrical power and increased risk of breakdown caused by undesired influences on the electronic components by the temperature and/or humidity of surrounding air. In addition, the motor is mounted on a rotary member and a rotary joint has to be established to transmit electrical power, leading to high risk of failure.

The system disclosed herein is aimed at solving and/or alleviating drawbacks of the known devices by providing a fluid turbine with fluid-tiltable blades.

### SUMMARY

In accordance with the present disclosure, a vertical axis fluid turbine is provided, comprising: a generator, a shaft mounted above the generator, and a plurality of blade sets. A blade set comprises a blade rod rotatably connected to the shaft and carrying blades arranged on opposite sides of the shaft. Each blade is asymmetrically divided into first and second moment-inducing sections located on opposite sides of the blade rod. The first moment-inducing section is greater in area than the second moment-inducing section. Each blade is provided, at a predetermined location thereof, with a winglet. Stops for limiting the swiveling of the blade are arranged on the blade set. When the blade set is moved so that the blades thereof are located in a windward position and leeward position respectively, the blades are automatically and easily set in an optimum pressure-receiving condition and a least fluid-resistance condition, respectively, for receiving fluid energy from variable directions, so that the shaft is rotatable even with low fluid speed to achieve optimum power generation performance. Further, no complicated swiveling structure is needed for the blade.

In one exemplary aspect, the present disclosure is directed to a fluid-driven turbine. It includes a main driving shaft defining a shaft axis and a plurality of blade sets symmetrically disposed about the main driving shaft. Each of the plurality of blade sets includes a rod extending radially from the main driving shaft in a direction transverse to the shaft axis. The rod defines a rod axis. Each blade set also includes a fluid-tiltable blade connected to the rod and extending along the direction of the rod axis. It has an airfoil shape in cross-section with a leading edge, a trailing edge, and a maximum thickness. The blade is asymmetrically divided into first and second moment-inducing sections located on opposite sides of the rod with the first moment-inducing section being greater in area than the second moment-inducing section. Also, it is rotatable about the rod axis between an optimum pressure-receiving position and a least fluid-resistance position for receiving fluid energy from variable directions. The blade sets also include a stopper system limiting rotation of the blade about the rod axis to a rotation range between the optimum pressure-receiving position and a least fluid-resistance position.

In one exemplary aspect, the present disclosure is directed to another fluid-driven turbine. It includes a main driving shaft defining a shaft axis and a plurality of blade sets symmetrically disposed about the main driving shaft. Each of the plurality of blade sets includes a blade set frame extending radially from the main driving shaft in a direction transverse to the shaft axis, and includes a rod defining a rod axis. The rod extends from the blade set frame in a direction substantially parallel to the shaft axis. Each also includes a fluid-tiltable blade connected to the rod and extending along the direction of the rod axis. The blade is divided asymmetrically into first and second moment-inducing sections located on opposite sides of the rod with the first moment-inducing section being greater in area than the second moment-inducing section. The blade is rotatable about the rod axis between an optimum pressure-receiving position and a least fluid-resistance position for receiving fluid energy from variable directions. A stopper system comprises a stopper disposed on the blade set frame and protruding in the direction of the shaft axis from the blade set frame. The stopper being positioned to physically limit rotation of the blade about the rod axis.

In one exemplary aspect, the present disclosure is directed to another fluid-driven turbine. It includes a main driving shaft defining a shaft axis and a rod extending transverse to the shaft axis on opposing first and second sides of the main driving shaft. The rod defines a rod axis. It also includes a first fluid-tiltable blade fixed to the rod on the first side of the main driving shaft and extending along the direction of the rod axis, and includes a second fluid tiltable blade fixed to the rod on the second side of the main driving shaft and extending along the direction of the rod axis. The first and second tiltable blades are rotatable about the rod axis relative to the main driving shaft. Each of the first and second blades are asymmetrically divided into first and second moment-inducing sections located on opposite sides of the rod with the first moment-inducing section being greater in area than the second moment-inducing section. The first and second blades are rotatable about the rod axis between an optimum pressure-receiving position and a least fluid-resistance position. The first blade is fixed to the rod at about a 90 degree angle relative to the second blade such that when the first blade is in the optimum pressure-receiving position, then the second blade is in the least fluid-resistance position, and when the second blade is in the optimum pressure-receiving position, then the first blade is in the least fluid-resistance position. A stopper system comprises a stopper fixed to and protruding from a first side of the main driving shaft. The stopper is sized and positioned to cooperatively limit the rotation of the rod about its axis.

The foregoing object and summary provide only a brief introduction to the present invention. To appreciate fully these and other objects of the present invention as well as the invention itself, all of which will become apparent to those skilled in the art, the following detailed description of the invention and the claims should be read in conjunction with the accompanying drawings. Throughout the specification and drawings, identical reference numbers refer to identical or similar parts.

Many other advantages and features of the present invention will be manifested to those versed in the art upon making reference to the detailed description and the accompanying sheets of drawings, in which a preferred structural embodiment incorporating the principles of the present invention is shown by way of illustrative example.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view of a vertical axis fluid turbine constructed in accordance with a preferred embodiment of the present invention;

FIG. 2 is an exploded view of the vertical axis fluid turbine of the present invention;

FIG. 3 is an exploded view of a blade set of the vertical axis fluid turbine in accordance with the preferred embodiment of the present invention;

FIGS. 4 and 5 are perspective views illustrating the operation of the vertical axis fluid turbine of the present invention;

FIG. 6 is a perspective view illustrating the first winglet of a blade of the blade set that receives wind pressure to swivel the blade upward;

FIGS. 7a, 7b, 7c illustrate the operation of the blades swiveling upward from a horizontal state to a vertical state;

FIG. 8 schematically demonstrates the blade in a horizontal state receiving wind coming from a different direction to develop a lifting force;

FIG. 9 is a perspective view illustrating the operation of the vertical axis fluid turbine of the present invention;

FIGS. 10a, 10b, 10c illustrate the operation of the blades swiveling from a vertical state to a horizontal state;

FIGS. 11 and 12 are perspective views illustrating the operation of the vertical axis fluid turbine of the present invention; and

FIG. 13 is a perspective view illustrating a blade constructed in accordance with another embodiment of the present invention.

FIGS. 14 and 15 are illustrations of exemplary blade sets in accordance with another embodiment.

FIGS. 16A-E and 17A-E are illustrations of an exemplary blade set in a series of positions showing blade orientation relative to a flowing fluid.

FIG. 18 is an illustration of an exemplary fluid turbine in accordance with another embodiment.

FIG. 19 is an illustration of exemplary blade sets in accordance with the embodiment of FIG. 18.

FIG. 20 is an illustration of a blade system in accordance with the embodiment of FIG. 19.

FIG. 21 is an illustration of a cross-section of a blade taken along line 21-21 in FIG. 20.

FIG. 22A is an illustration of an exploded blade system attachable with a main shaft.

FIG. 22B-D are illustrations of an exemplary blade sets in a series of positions showing blade orientation relative to a flowing fluid.

FIGS. 23A-C and 24A-C are illustrations of an exemplary stopper system usable with the embodiment of FIG. 18.

### DETAILED DESCRIPTION

The following descriptions are of exemplary embodiments only, and are not intended to limit the scope, applicability or configuration of the invention in any way. Rather, the following descriptions provide a convenient illustration for implementing exemplary embodiments of the invention. Various changes to the described embodiments may be made in the function and arrangement of the elements described without departing from the scope of the invention as set forth in the appended claims.

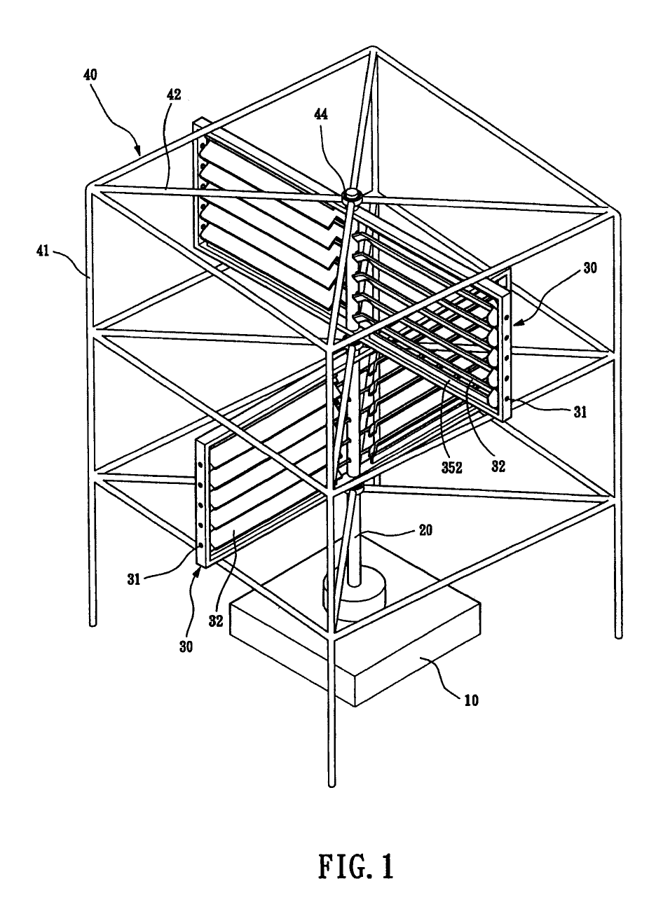

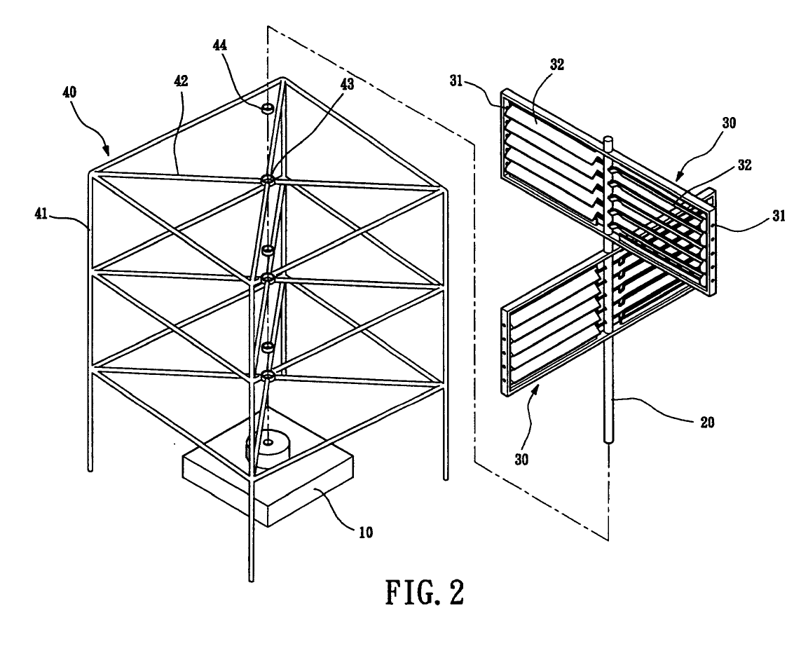

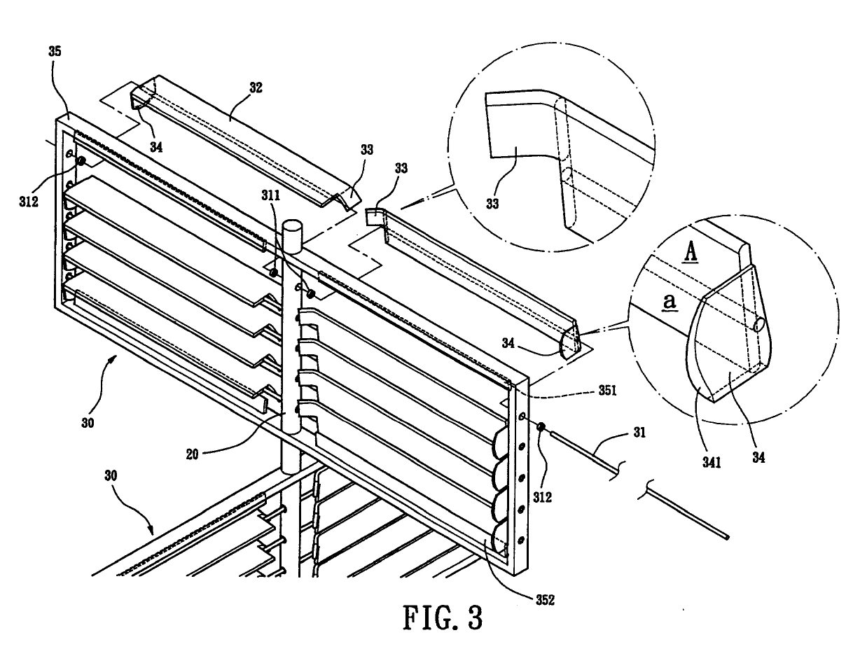

With reference to the drawings and in particular to FIGS. 1-3, a vertical axis fluid turbine constructed in accordance with the present invention comprises a generator 10, a shaft 20 mounted above the generator 10, a plurality of blade sets 30, and a support frame 40. The blade set 30 comprises a plurality of blade rods 31 each carrying two blades 32 and rotatably mounted to the shaft 20, wherein the blades 32 are located on opposite sides of the shaft 20 and are provided with means for facilitating swiveling of the blades 32 so that the blades 32, which are respectively on a windward side and a leeward side, can be manipulated with aerodynamic force caused by air flows to automatically and easily set in an optimum pressure-receiving position and least wind-resistance position, respectively, for receiving wind energy from variable directions and thus providing optimum power generation performance even in low wind speed conditions. A detailed description for an exemplary embodiment of the present invention will be given as follows.

The generator 10 functions to convert rotary mechanical energy into electrical power.

The shaft 20 is mounted above the generator 10 and functions to drive the generator 10 for generation of power.

The blade sets 30 are arranged in such a way that an upper-level blade set and lower-level blade set, which are stacked together in an alternate manner to serve as a unitary module, are fixed to the shaft 20. If desired, either a single pair of upper-level and lower-level blade sets can be used or, alternatively, based on the local topography and wind field, one or more additional pairs of blade sets can be further stacked to increase power generation efficiency.

The blade set 30 comprises a plurality of blade rods 31 rotatably mounted to the shaft 20 with bearings 311 arranged in the rotation connection to reduce the likelihood of damage or breakdown. Each blade rod 31 is provided with blades 32 on opposite sides of the shaft 20 and each blade 32 is divided asymmetrically into two moment-inducing sections on the opposite sides of the blade rod 31 with one moment-inducing section being greater in area than the other one. In other words the surface area “A” of the section of the blade 32 above the blade rod 31 is greater than the surface area “a” of the section of the blade 32 that is below the blade rod 31. Preferably, the blade rod 31 is set at a location approximately two-thirds of the widthwise dimension of the blade 32 so that the surface area of two-thirds of the width of the blade 32, when facing windward, receive a wind pressure greater than the surface area of the remaining one-third of the width of the blade 32. When the blades 32 swivel to a substantially vertical state, the lower edge of each blade 32 engages with the upper edge of the blade 32 below. Each blade 32 has an inner end on which a first winglet 33 is formed at a preset internal angle to concentrate the incoming wind pressure and thus induce moment on the blade 32 for swiveling. The blade 32 also has an outer end forming a second winglet 34, which is substantially normal to the blade 32 for receiving wind pressure and preventing loss of wind pressure. Further, since the rotational axis of the blade 32 is not set at the geometric center thereof, a counterweight is selectively added to the lower surface section “a” of the blade below the blade rod 31 to set the center of gravity of the blade 32 at the rotational axis of the blade rod 31. This will set the blade 32 in a condition where the forces are balanced when the blade 32 is in a horizontal state and thus allowing the blade 32 to easily swivel, even when only being acted upon by the low wind pressure of a light breeze. The second winglet 34 has a portion configured as a lifting airfoil 341 similar to an airplane wing, serving to provide additional lifting force to help rotation of the shaft 20 in the situation where the blade 32 is rotated to a horizontal state. To enhance the stability and firmness of the blade rod 31, the blade set 30 comprises a frame 35 that rotatably supports the ends of the blade rods 31 with bearings 312 set at the rotation connections. Stops 351, 352 are formed at upper and lower internal edges of the frame 35 (or alternatively, the stops are formed on the shaft 20) to automatically stop the swiveling of the uppermost and lowermost blades 32 when they approach a vertical state, thereby fixing the blades.

The support frame 40, serving to support the shaft 20 in position, comprises a plurality of horizontal and vertical bars 41 that form a multi-level framework, each level containing diagonal bars 42 interconnecting each other at an intersection in which a bore 43 is defined to receive and retain a bearing 44 for the extension and rotation of the shaft 20.

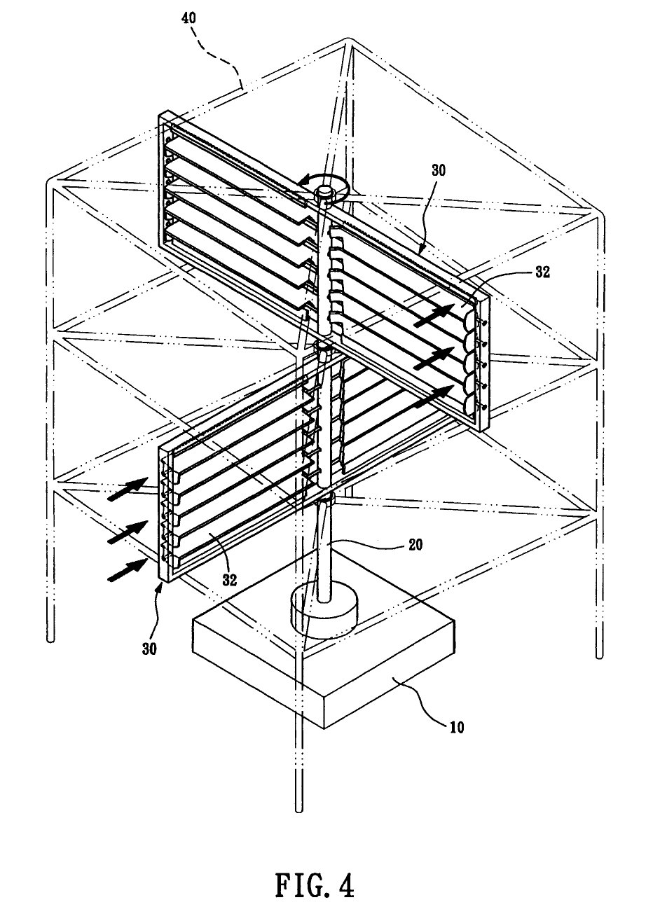

Also referring to FIG. 4, when the fluid turbine of the present invention is acted upon by wind, as indicated by the arrows, the blades 32 on one side of the upper-level blade set 30 are acted upon by the aerodynamic force of the wind to swivel automatically to a vertical state where the vertical blades 32 receive the greatest wind pressure, while the blades 32 on the other side of the upper-level blade set 30, also due to aerodynamic force, automatically swivel to a horizontal state, which is the state of the least wind resistance, so that the blade set 30 drives the shaft 20 to rotate in, for example, a counter-clockwise direction. At the same time, the lower-level blade set 30 is substantially parallel to the air flow of the wind thereby losing wind pressure (and thereby losing power), but the blades 32 on one side of the lower-level blade set 30 are in a horizontal state, getting ready to be acted upon by the aerodynamic force of the wind to start swiveling to a vertical state.

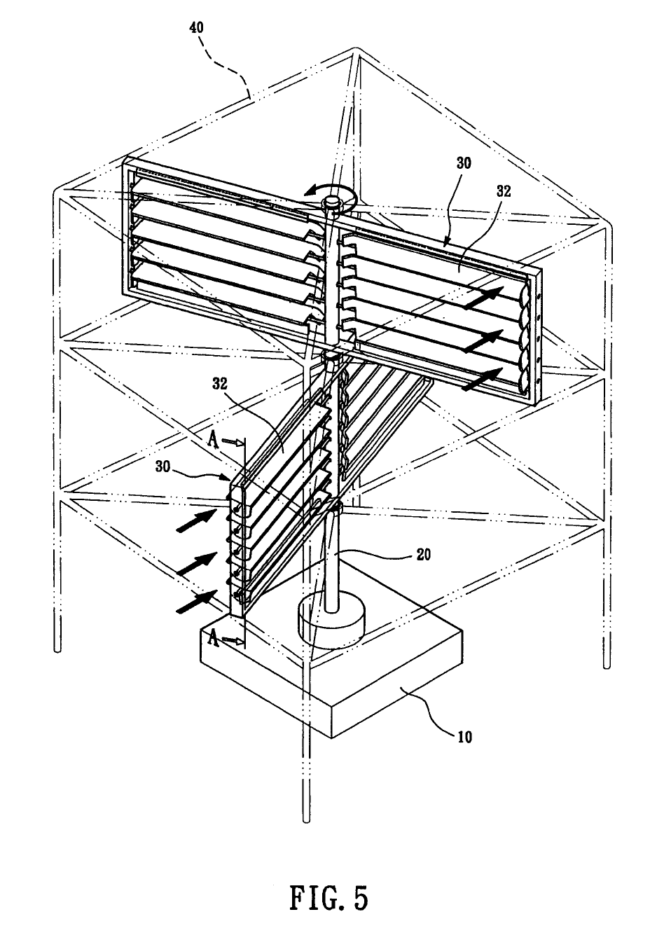

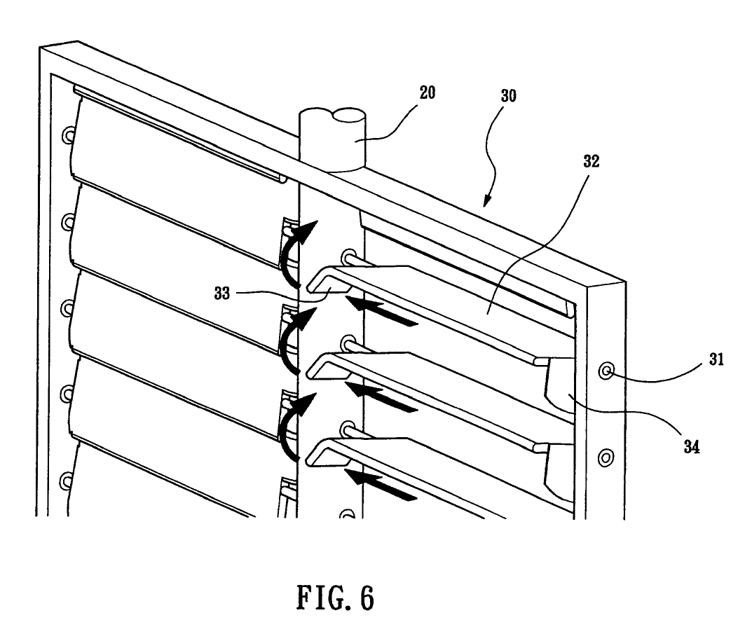

Also referring to FIGS. 5, 6, and 7, with the upper-level and lower-level blade sets 30 further rotating counter-clockwise, the blades 32 of the lower-level blade set 30 that are in a horizontal state ready to receive the action of the aerodynamic force of the wind (the blades 32 of the other side of the lower-level blade set 30 being in a vertical state) receive the incoming wind pressure with the first winglets 33 thereof. This, together with the fact that the surface area of the one section of the blade 32 on one side of the blade rod 31 is greater than that of the other section of the blade 32 on the other side of the blade rod 31, as well as the counterweight added to the blade 32, provides the blade 32 with enhanced moment acting thereon, allowing the blades 32 that are in a horizontal state to automatically and easily swivel upward.

When the blades 32 swivel and approach a vertical state, the blades 32 engage and fix against each other with the uppermost and lowermost blades 32 being brought into contact with and automatically stopped and fixed by the stops 351, 352. At this time, the blades 32 together form a vertical surface that serves as an optimum wind-receiving surface which, with the aid of the second winglets 34, effectively receives the wind pressure for driving the rotation of the shaft 20.

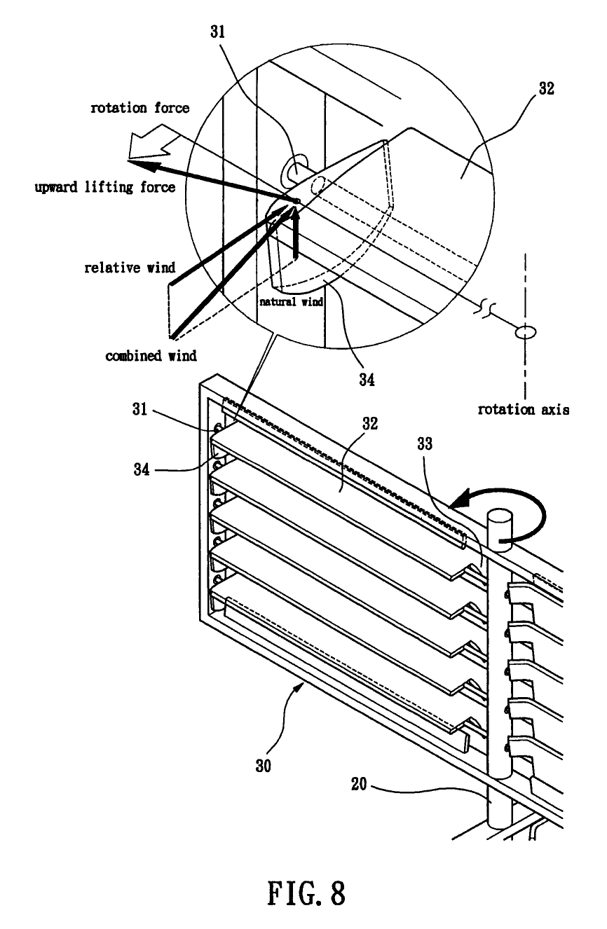

Referring to FIG. 8, when the blades 32 on one side of the upper-level blade set 30 are in a leeward position, the blades can reduce the wind resistance due to the horizontal state thereof at that moment, and further, the second winglets 34 that at this moment are in a vertical state and extending downward so that the second winglets 34 can receive wind coming from a different direction and induce an upward lifting force according to the principles of aerodynamics to thereby generate a rotation force for assisting rotation of the blade set 30 about the shaft 20.

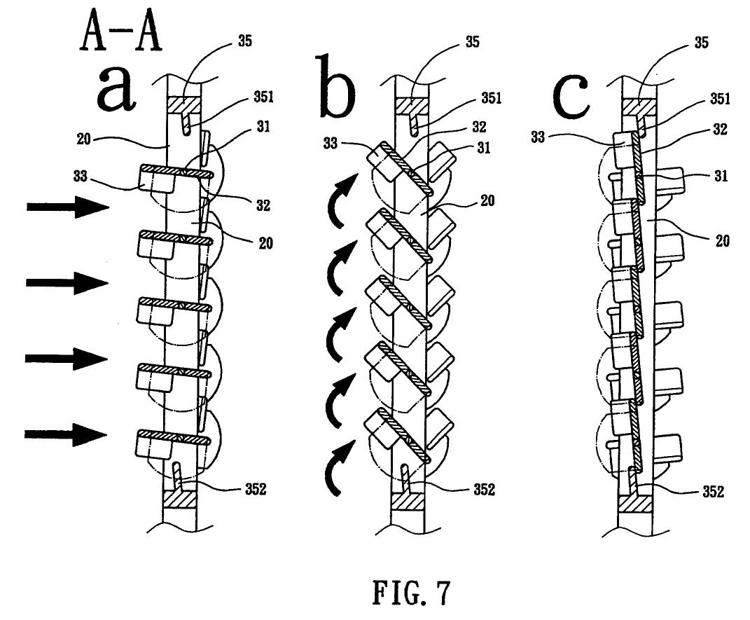

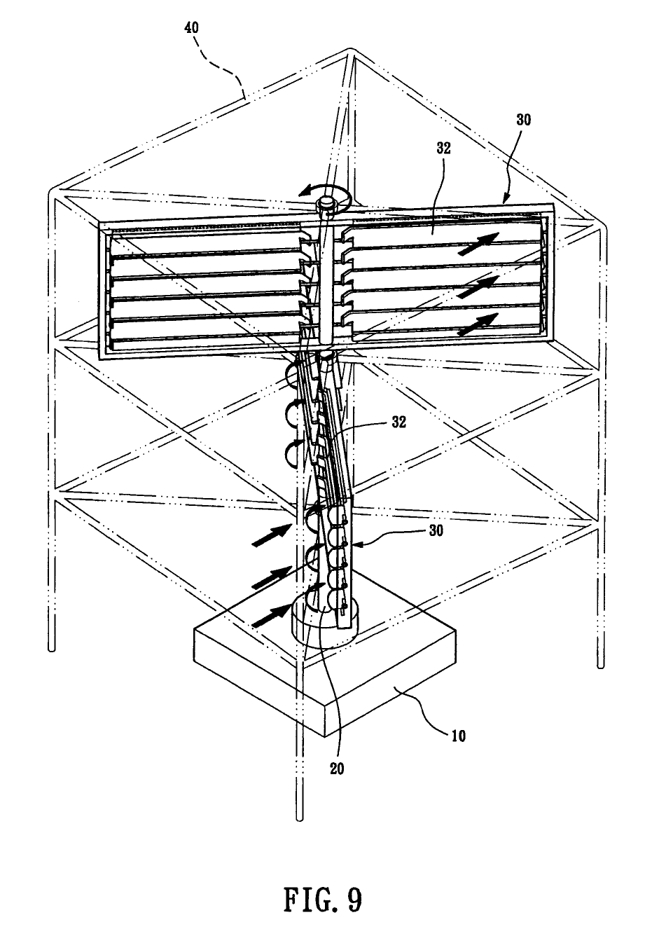

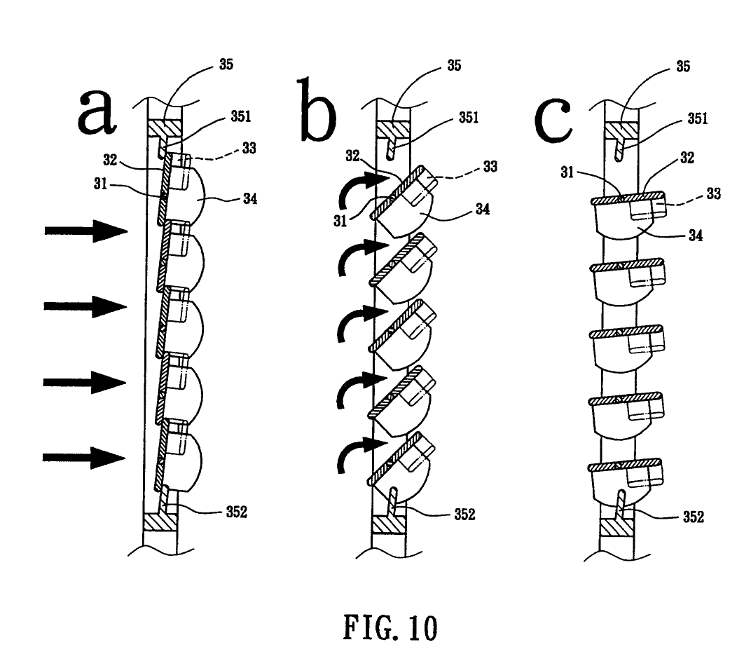

With reference to FIGS. 9 and 10, which demonstrate the operation of the fluid turbine of the present invention succeeding that shown in FIG. 7, when the blades 32 on one side of the lower-level blade set 30 start to receive wind pressure, swiveling to form a vertical surface, the blades 32 on the other side of the lower-level blade set 30 that were originally in a vertical state start to get to a leeward position. Since the surface area of one section of the blade 32 on one side of the blade rod 31 is greater than the other section, an enhanced moment is induced, which helps the blade 32 that is in a vertical state to easily swivel to a horizontal state, a less wind-resistant condition.

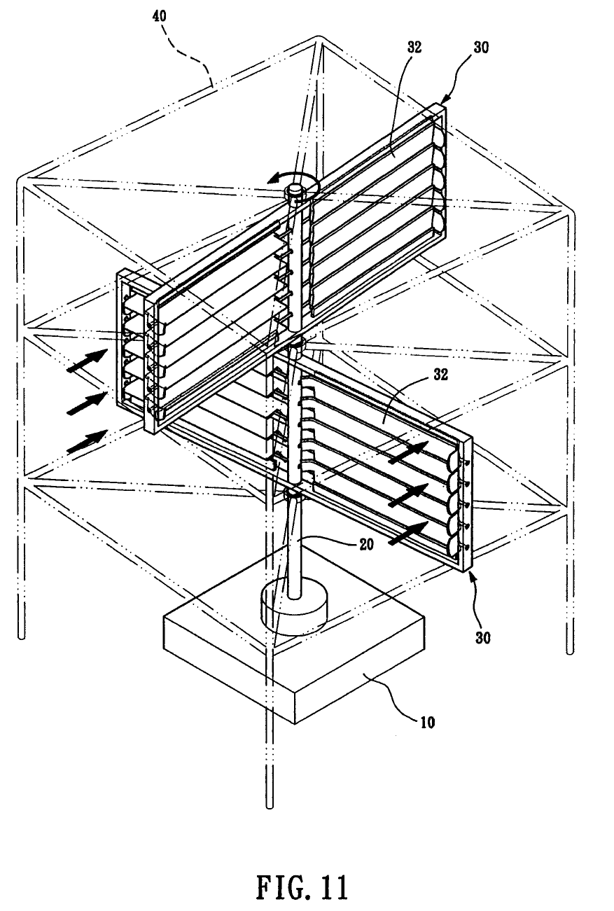

Referring to FIG. 11, when the blades 32 of the side of the lower-level blade set 30 become vertical and are set to receive the greatest wind pressure, the blades 32 of the other side of the lower-level blade set 30 are located in a leeward position and provide the least wind resistance. At this moment, the upper-level blade set 30 is substantially parallel to the direction of air flow of the wind, thus losing wind pressure (losing power) and the lower-level blade set 30 succeeds the rotation force of the upper-level blade set 30.

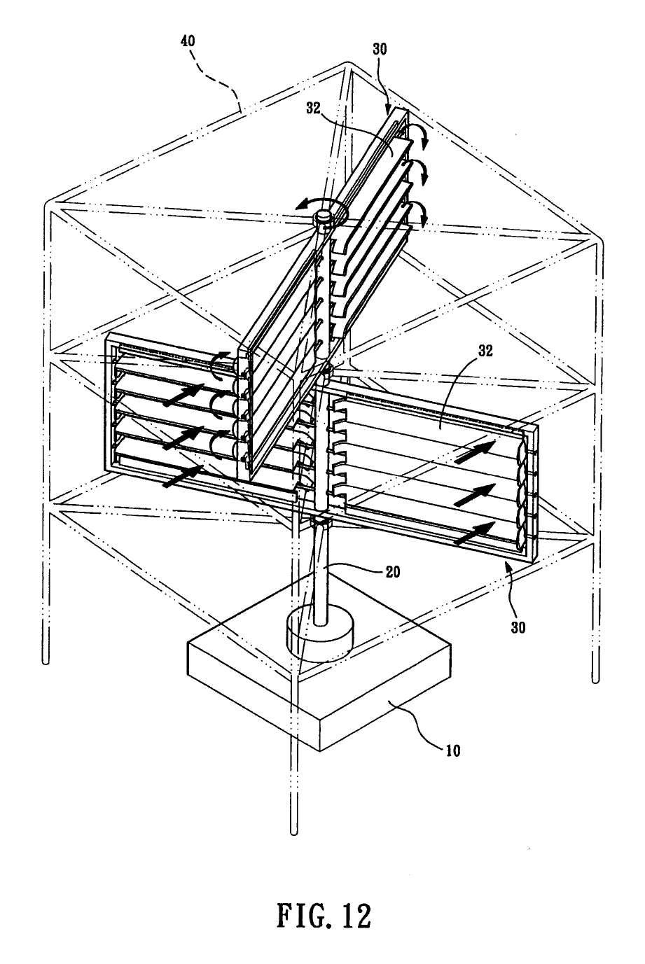

Referring to FIG. 12, when the lower-level blade set 30 is acted upon by the wind to rotate further, the upper-level blade set 30 will be moved to a windward position again, causing the blades 32 on one side thereof, which were originally in a horizontal state, to swivel to a vertical state, while the blades 32 of the other side of the upper-level blade set 30, which were originally in a vertical state swivel to a horizontal state, whereby the upper-level blade set 30 succeeds the rotation. As such, wind energy from variable directions can be intercepted and optimum power generation performance can be ensured for rotating the shaft 20 to drive the generator 10 even at low wind speeds.

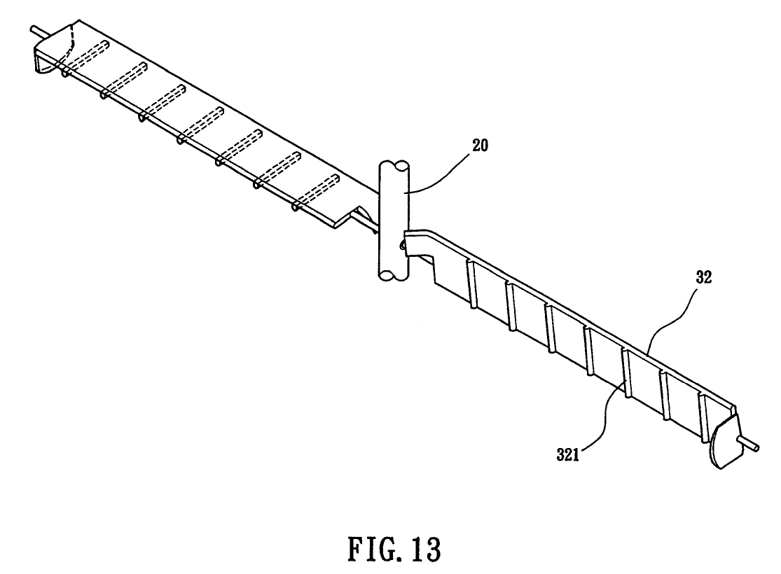

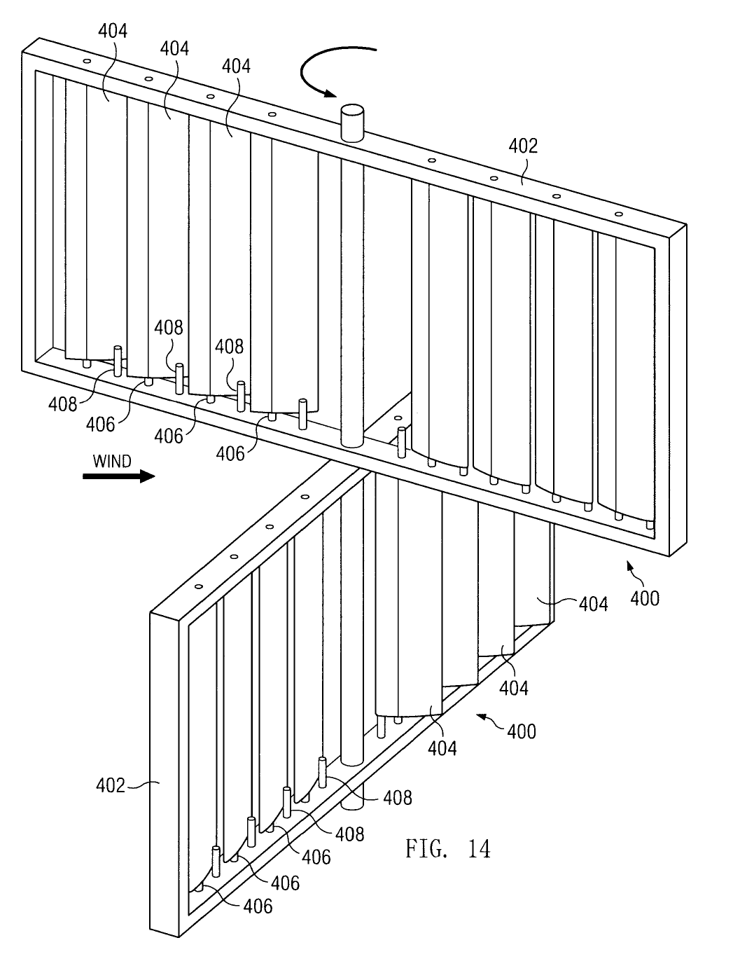

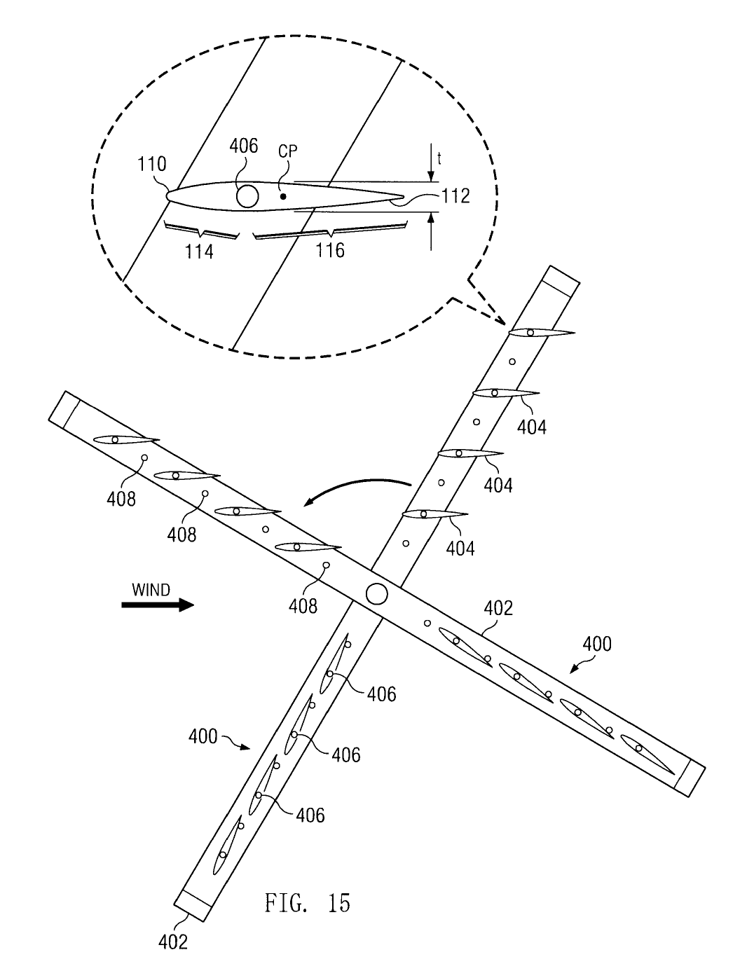

Referring to FIG. 13, if desired, ribs 321 can be formed on the surface of the blade 32 to increase the structural strength thereof and also to help receive wind pressure.

FIGS. 14 and 15 show alternative blade sets 400 having vertically oriented blades 404. The blade sets 400 include a blade set frame 402 containing a plurality of blades 404 and blade rods 406. The blade rods 406 extend from one side of the blade set frame 402 to the other. FIG. 14 shows a plan view of the blade sets 400 and FIG. 15 shows a top view without the top rail of the blade set frame 402.

In this embodiment, the blade rods 406 are oriented to lie substantially parallel with the shaft 20, with the blades 404 themselves attached to the blade rods 406. In the embodiment shown, like the embodiments described above, the system includes upper and lower level blade sets 400.

The blades 404 rotate with the rod 406 within the blade set frame 402 between an optimum pressure receiving position and a least wind-resistance position. Pressure against the blades 404 rotates the blade sets 400 to turn the shaft 20 in the manner described above with reference to FIG. 1. Bearings (not shown) rotatably connect the blade rods 406 to the blade set frame 402. In the embodiments shown, each blade 404 acts independent of all other blades 404. Rotation of the blades 404 between the optimum pressure receiving position and a least wind-resistance position is limited by stops 408 disposed about the blade set frame 402. In this exemplary embodiment, the stops 408 are protruding structures that extend from the blade set frame 402 into the rotation path of the respective blades 404. The blades 404 physically contact the stops 408 when in the optimum pressure receiving position and are held in place there by the force of the fluid or wind. In the example shown, the stops 408 protrude in the same direction as the blade rods 406. Accordingly, as indicated in FIG. 14, the stops 408 and the blade rods 406 sit on the same side of the blade set frame 402.

FIG. 15 shows the blade set 400 with the top rail of the blade set frame 402 removed to provide a view of the blades 404, rods 406, and stops 408. In this embodiment, the blades 404 are shaped as symmetric airfoils. They have a leading edge 110, a trailing edge 112, and a maximum thickness t arranged forward of a center point CP between the leading and trailing edges 110, 112. In the embodiment shown, the blade rod 406 is disposed at the area of maximum thickness t. Because the blade rod 406 is disposed offset from the centerpoint CP, the rod 406 is asymmetrically disposed in the airfoil, dividing the blade 402 into a leading portion 114 and a trailing portion 116. Accordingly, as explained above with reference to FIGS. 14 and 15, from a side view, each blade 404 is divided into two moment-inducing areas on opposite sides of the blade rod 406, but on the same side of the blade. Here, one moment-inducing section is defined by the area of the leading portion 114 on one side of the blade and the other is defined by the area of the trailing portion 116 on one side of the blade. In some examples, the blade rod 406 is disposed to divide the length of the blade 404 so that from a side view, approximately two-thirds of the surface of the blade 404 lies on one side of the rod and approximately one-third lies on the other. Accordingly, from a side view, the blade surface portion making up two-thirds of the width of the blade 404, when facing windward, receives a wind pressure greater than the surface portion area of the remaining one-third of the width of the blade 404, thereby causing the blade to pivot with or about the rod relative to the blade set frame 402.

As indicated in FIG. 15, the single stop 408 for each blade 404 engages the trailing portion 116 of the respective blade 404, but is spaced from the rod 406 so as to not interfere with rotation of the leading portion 414. In this manner, the stops 108 physically block the blades 404 from over rotation while still permitting them to rotate.

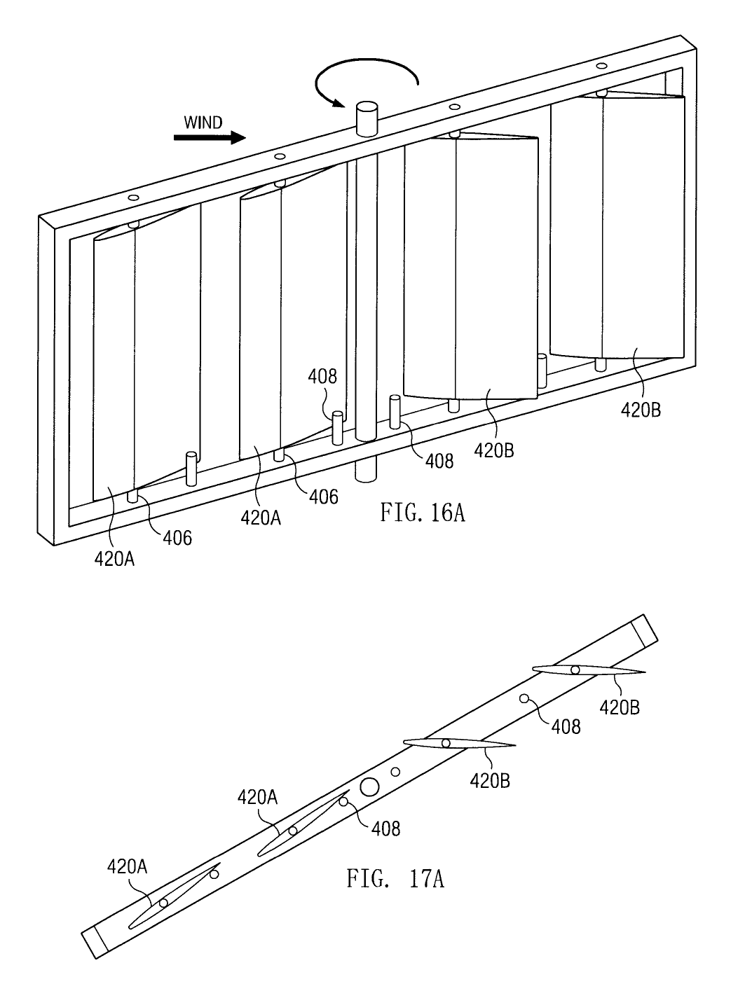

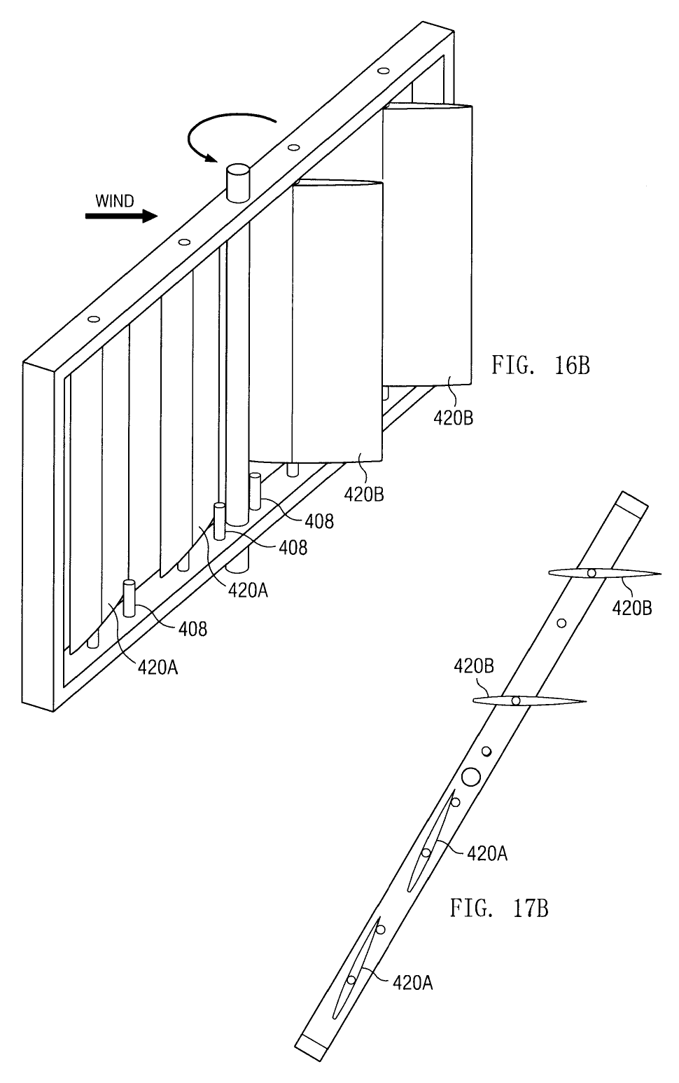

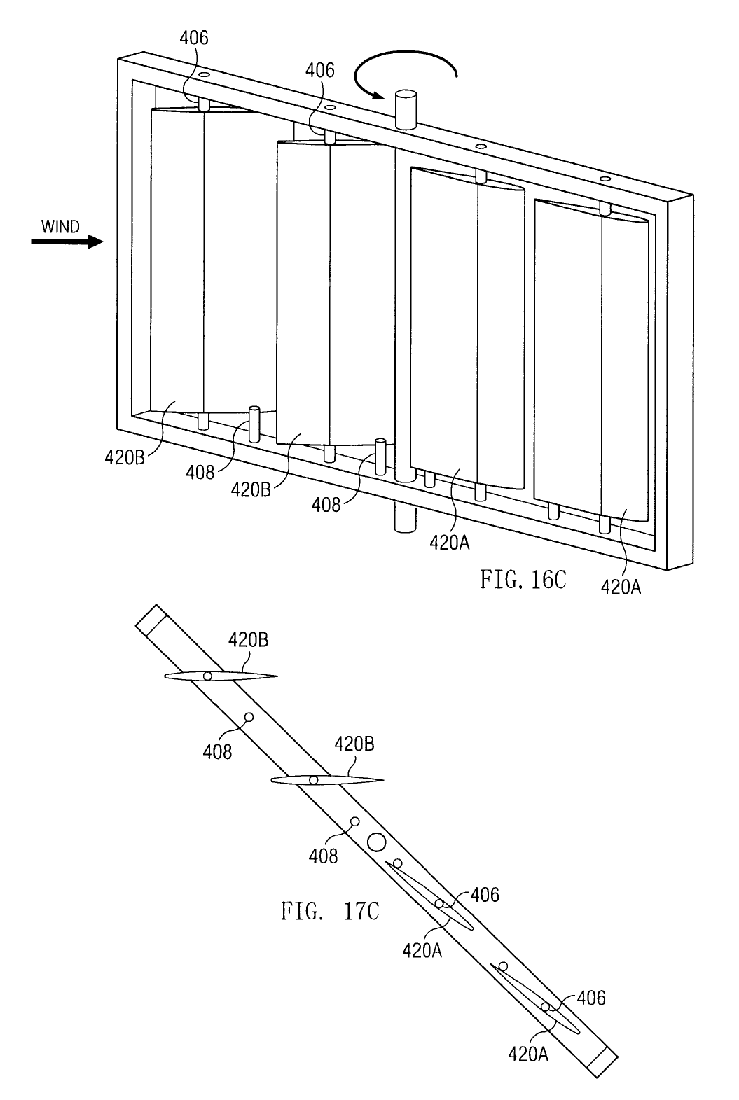

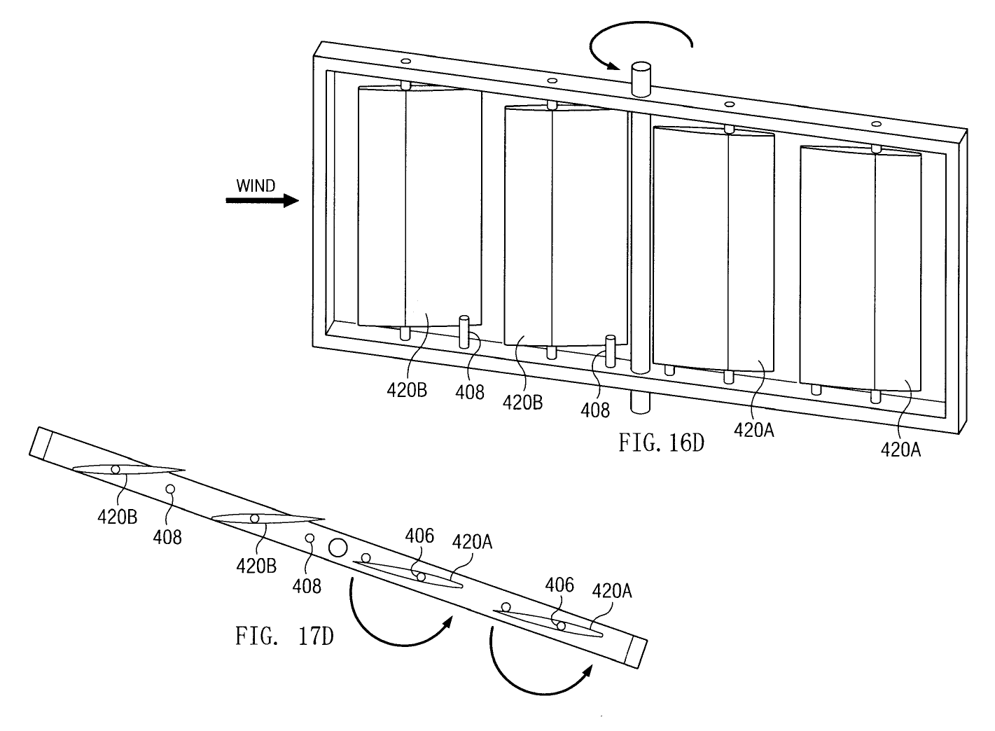

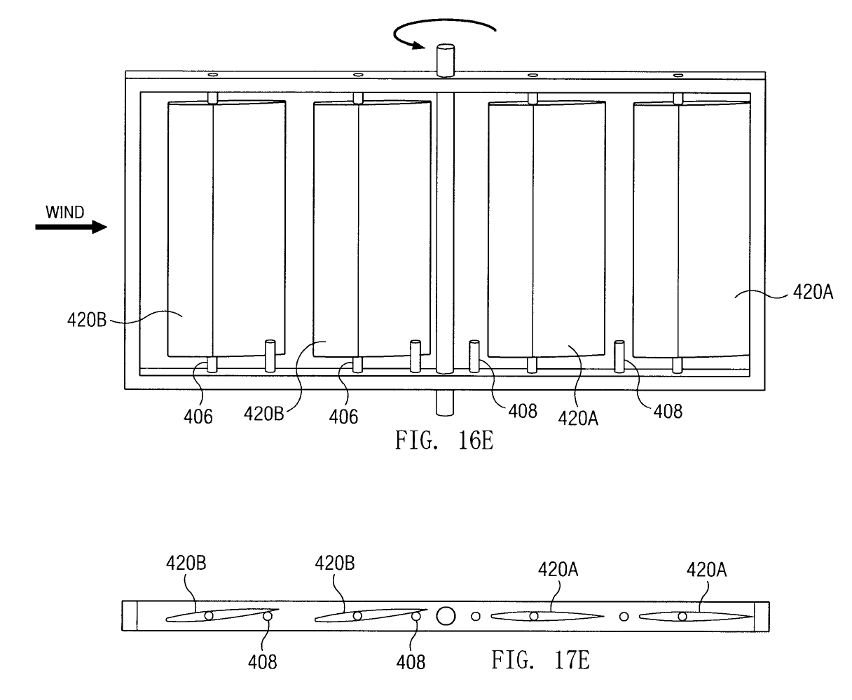

The blade position of each blade 404 at any one point in time set depends upon its location relative to the wind direction. This is shown in and further clarified with respect to FIGS. 16A-E and 17A-E. These figures show an alternative blade set utilizing only four blades in various positions during a rotation cycle. For reference the blades are referred to herein as groups, with the first group comprising blades 420A and the second group comprising blades 420B. The blades 420A and 420B of course are responsive to the wind depending on their position and the position of the stops.

Referring first to FIGS. 16A and 17A, the wind is shown blowing in a direction from left to right. In this embodiment, the blades 420A are in the optimum pressure receiving position and the blades 420B are in the least wind-resistance position. The wind or fluid forces the blades 420A against the stops, thereby limiting their capacity to further pivot relative to the blade set frame. Because of the non-symmetric location of the rod in the blade, the blades 420B lie with the leading edge of each airfoil facing into the wind, and with the trailing edge of the airfoil trailing. The airfoil's aerodynamic shape minimizes drag as the blades move upstream against the wind.

FIGS. 16B and 17B show the blade set further rotated. The position of the blades 420A is unchanged relative to the blade set frame while the position of the blades 420B changes only as the wind blows against the airfoil to orient the blades to have the least drag. FIGS. 16C and 17C show similar positions. FIGS. 16D and 17D show the blade set rotated far enough so that the wind begins to catch the trailing end of the blades 420A, the asymmetrical location of the blade relative to the rod causes the blades 420A to pivot about the respective rods so that the leading edge of each airfoil is facing windward. FIGS. 16E and 17E show the blades 420A facing windward and shows the trailing portion of the blades 420B engaging with the stops to limit further rotation of the blades 420B relative to the blade set frame. Accordingly, the blades 420B now enter the optimum pressure receiving position while the blades 420A enter the least wind-resistance position.

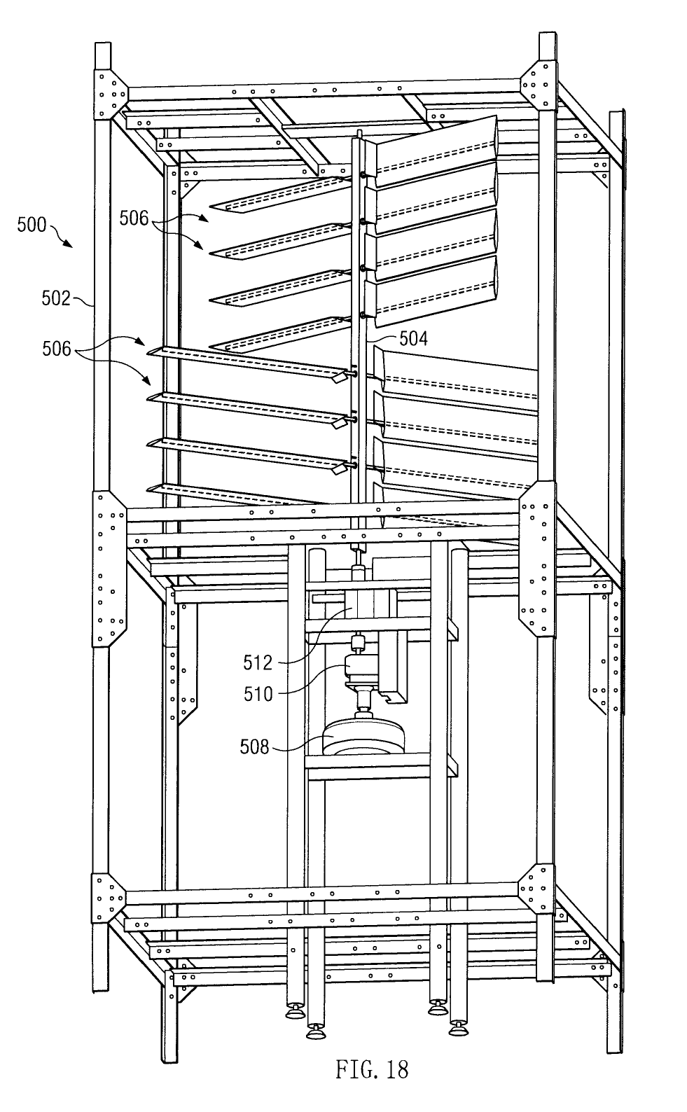

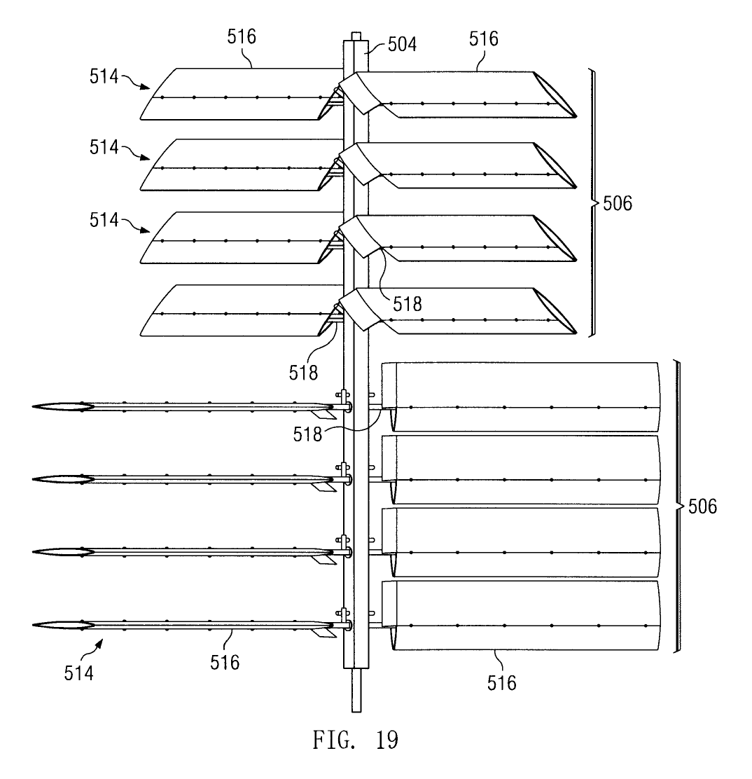

FIG. 18 shows an exemplary fluid turbine 500 according to one aspect of the present invention. The turbine 500 includes a frame 502, a main driving shaft 504, and blade sets 506. In addition, the frame 502 supports a generator 508, a gear box 510 disposed between the generator and the main driving shaft 504, and a torque sensor 512. The frame 502 may be formed or a rigid or sturdy material, that in some embodiments, may be corrosion resistant which can increase expected life in corrosive environments, such as in some underwater environments that may use salt-water as the driving fluid. As can be seen, the blade sets 506 each connect to the main driving shaft 504 and cooperatively respond to fluid flow to rotate the main driving shaft 504 to generate energy. The generator 508 and the gear box 510 cooperate to render the turbine more efficient. In some examples, the gear box operates at a 500:1 output:input ratio. Gear boxes with any ratio may be utilized.

FIG. 19 shows the main driving shaft 504 and blade sets 506 independent of the frame 502. The example shown includes two blade sets 506, an upper level blade set and a lower level blade set In this embodiment, these are symmetrically arranged about the main driving shaft 504 to be offset from each other by 90 degrees. Each blade set 506 comprises a series of cantilevered blade systems 514 that each include blades 516 and a rod 518.

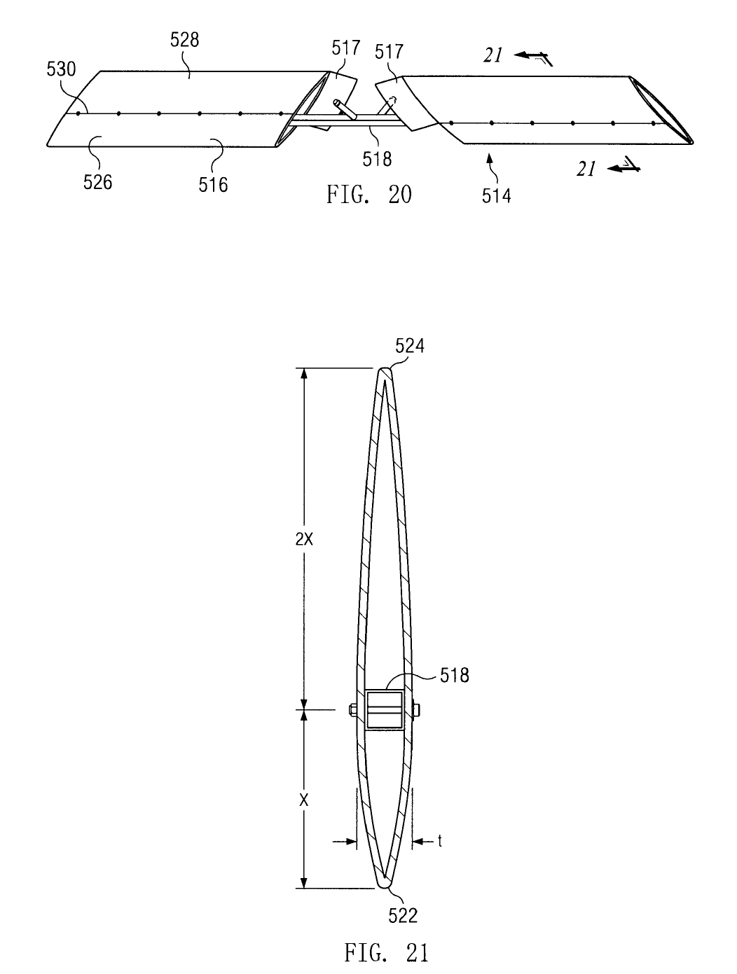

FIG. 20 shows an exemplary blade system 514 in greater detail. In this embodiment, the blade system 514 comprises two blades 516 connected by the rod 518. The blades 516 are fixed relative to each other and offset from each other by, for example, 90 degrees. Accordingly, when one blade 516 is positioned in the optimum pressure receiving position, the other blade 516 is positioned in the least wind resistance position. In this embodiment, each blade 516 has an inner end on which a first winglet 517 is formed at a preset internal angle to concentrate the incoming wind pressure and thus induce a moment on the blade 516 for swiveling. Although the blade appears to have a width extend in opposing directions on both sides of the rod 518, the winglet 517 is located on the blade 516 to be substantially entirely disposed at one side of the rod 518.

The rod 518 attaches the blade system 514 to the main driving shaft 504 (FIG. 19). The blades 516 attach to the rod 518 and rotate between a substantially vertical state or optimum pressure receiving position and a substantially horizontal state or least wind resistance position.

Furthermore, as can be seen in FIG. 21, the blades 516 are shaped as a symmetrical airfoil, having a rounded leading edge 522 and a tapering trailing edge 524. The maximum thickness t of the airfoil is disposed at or around the connection point of the rod 518, which is disposed closer to the leading edge than the trailing edge. In some embodiments, the distance from the leading edge to the rod is about twice the distance from the rod to the trailing edge. In the embodiment shown, the rod 518 extends substantially the entire length of the blades 516 that it supports. However, in other embodiments, the rod 518 extends only part-way through the blades 516 or alternatively, the blades 516 connect to ends of the rod 518.

As shown in the figures, the blade system 514 is cantilevered, without any direct support at the outer ends of the blades 516. By eliminating the blade set frame disclosed herein in alternative embodiments, overall drag may be reduced, which may result in increased efficiency. Further, when placed as shown, the system disclosed includes a vertical axis defined by the rotating driving shaft, but also includes multiple horizontal axes defined by the rods, about which the individual blades rotate. Accordingly, the present embodiment includes both vertical and horizontal axes.

As indicated in the figures, the airfoil shape of the blade 516 itself may be formed of two or more component parts. In the embodiments shown, the first component part 526 forms the leading edge 522 and the second component part 528 forms the trailing edge 524. The two components parts connect along a seam 530 extending at or around the location of the maximum thickness t of the airfoil. Because the location of the seam 530 may correspond with the location of the rod 518 within the airfoil, manufacturing and assembly processes may be more easily accomplished.

In the embodiment shown, the rod 518 includes a rectangular-shaped cross-section, and more particularly includes a square-shaped cross-section. The four side surfaces may simplify manufacturing by providing flat surfaces through which drilling and other processing may occur. In addition, because the surfaces are offset by 90 degrees, they may be used as reference points during manufacturing to identify the position required for the optimum pressure receiving position and the least wind resistance position.

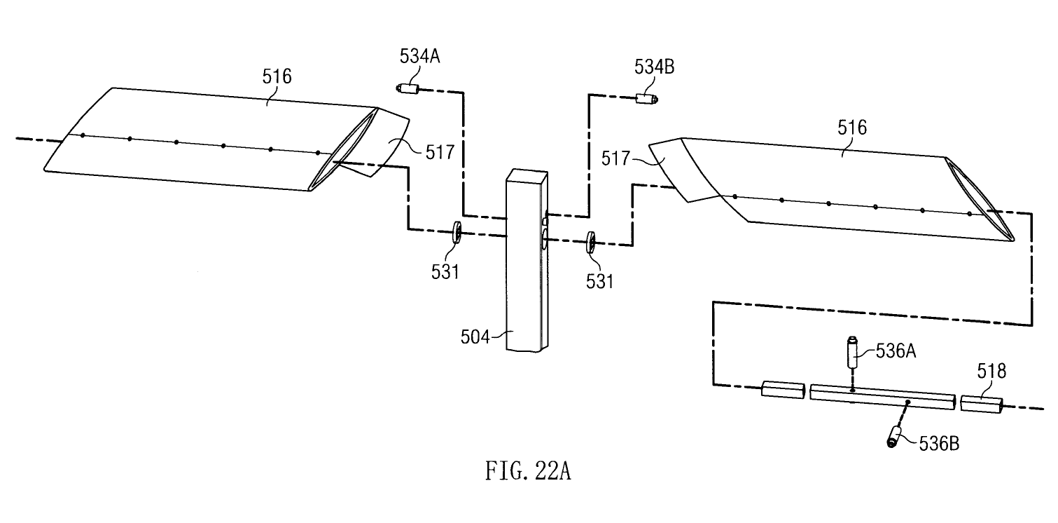

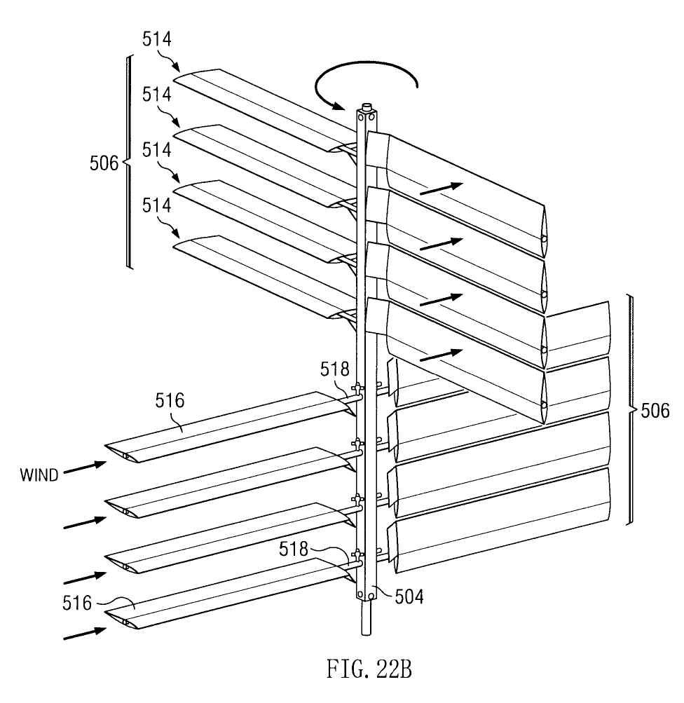

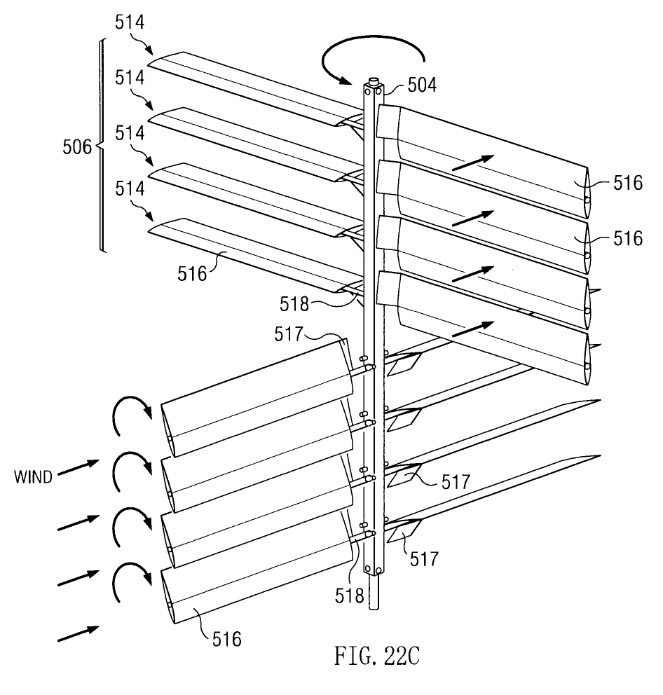

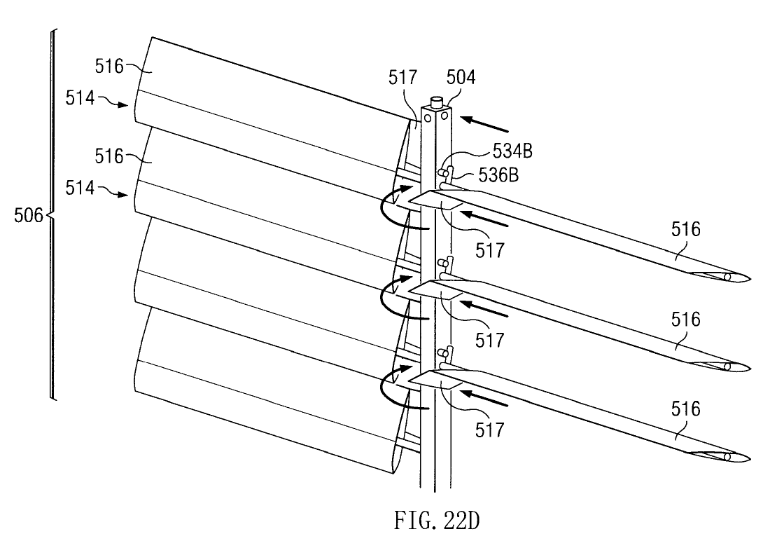

FIG. 22A shows the blade system 514 in an exploded state relative to the main driving shaft 504. As indicated, the blade system includes the blade 516 having winglets 517, and rod 518. In addition, a stopper system, discussed in detail further below, includes shaft stoppers 534A and B and rod stoppers 53A and B. The rod 516 extends through the main driving shaft 504 and pivots relative to the shaft 504 on bearings 531.

FIGS. 22B-D illustrate blade sets 506 reacting to fluid flow, such as windflow, in a manner similar to that shown in and described with reference to FIGS. 4, 5, and 6. As discussed above with reference to those figures, the blades' positions are driven by the fluid flow, with vertical blades 516 receiving the greatest wind pressure, while horizontal blades receive the least wind pressure. Thus, the blade set 506 drives and rotates the shaft 504. FIG. 22B shows the blades 516 on one side of the lower-level blade set 506 in a horizontal state, getting ready to be acted upon by the flowing fluid force to start swiveling to a vertical state.

Upon further rotation of the upper-level and lower-level blade sets 506, the horizontal blades 516 of the lower-level blade set 506 receive the incoming wind pressure at the winglets 517. This, together with the fact that the surface area of the one section of the blade 516 on one side of the blade rod 518 is greater than that of the other section of the blade 516 on the other side of the blade rod 518, provides the blade 516 with enhanced moment acting thereon, allowing the blades 516 that are in a horizontal state to automatically and easily swivel upward toward the vertical state.

When the blades 516 swivel and approach a vertical state, the blades 516 engage and fix against a stopper system further described below, so that the blades 516 together form a vertical surface that serves as an optimum wind-receiving surface which effectively receives the wind pressure for driving the rotation of the shaft 504, while those claims that were in the vertical state are swiveled to the horizontal state.

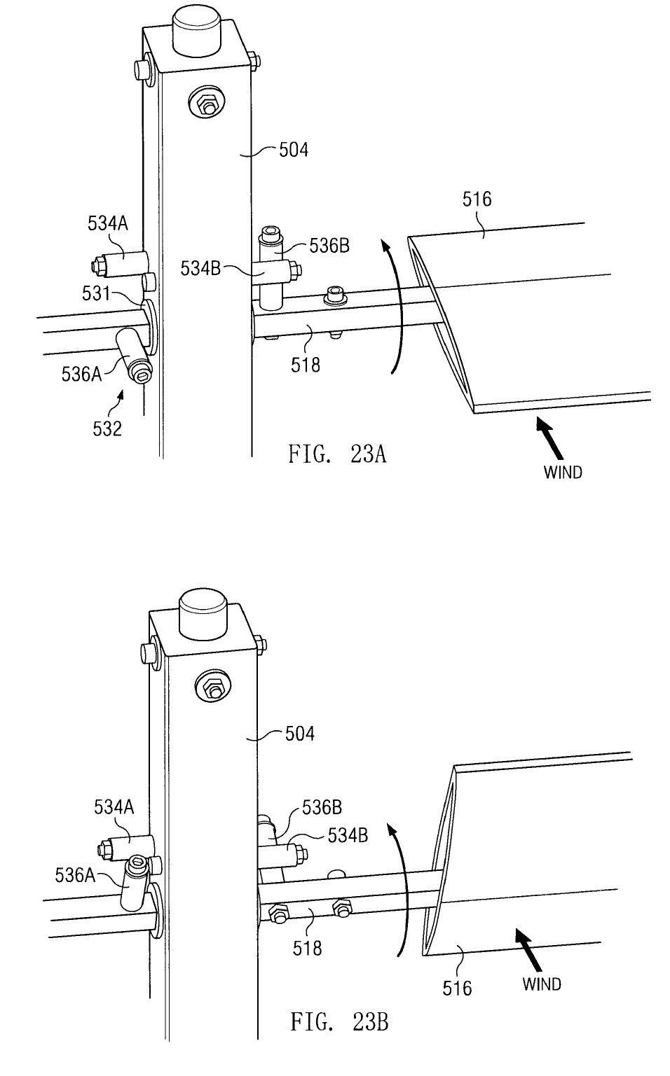

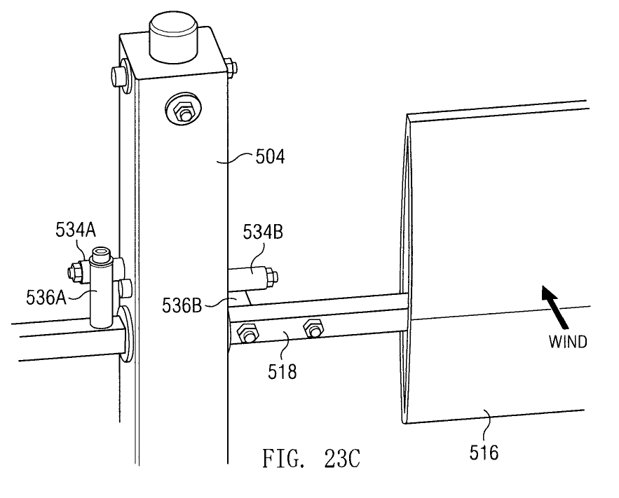

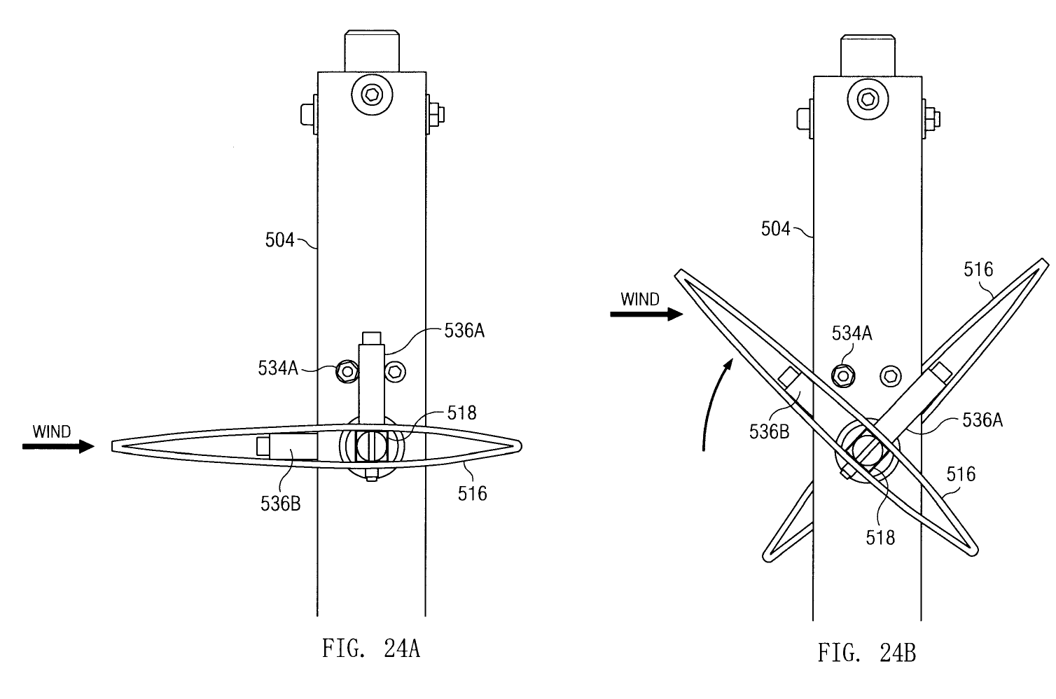

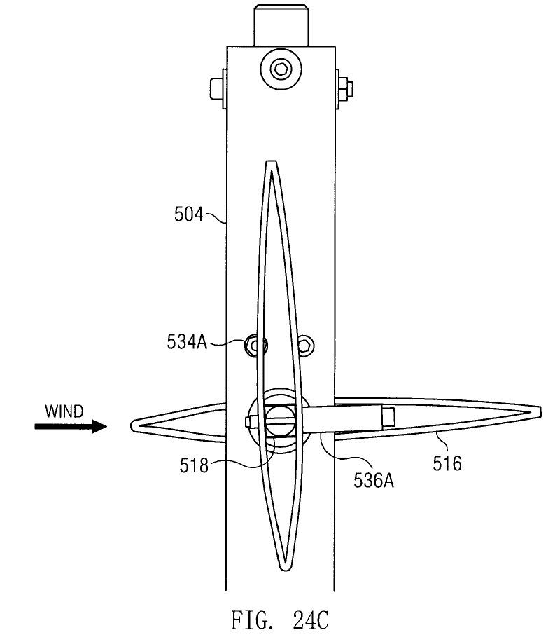

FIGS. 23A-23C and 24A-24C disclose the blade system connected to the main driving shaft 504, with the winglets removed. In use, the rod 518 extends through the main driving shaft 504. Bearings 531 permit the rod 518 to rotate relative to the driving shaft 504 so that the blades 516 can freely rotate between the optimum pressure receiving position and the least wind resistance position.

In the embodiment shown, like the rod 518, the driving shaft 504 has a square or rectangular cross-section. Accordingly, it includes faces normal to the axis of the rod 518. This permits additional componentry, such as a part of a stopper system 532, to be more easily attached to the main driving shaft 504. The stopper system 532 limits the amount of rotation of the blade system 514. By limiting the degree of rotation, the blade system 514 can be restricted to a range of motion between the optimum pressure receiving position and the least wind resistance position. This reduces the chance of over-rotation that might increase drag and reduce the efficiency of the overall fluid turbine.

The stopper system 532 includes shaft stoppers 534A and 534B on opposing side surfaces of the main driving shaft 504 and includes rod stoppers 536A and 536B offset from each other on the rod 518, and also disposed on either side of the main driving shaft 504, best seen in FIGS. 23A-23C. In the embodiment shown, both the shaft and rod stoppers 534, 536 are protruding elements rigidly attached to the respective shaft and rod and positioned to interface with each other to limit the shaft rotation. As can be seen in the figures, the shaft stoppers are rigidly connected to the main driving shaft 504, while the rod stoppers 536 are rigidly fixed to the rod 518 and therefore rotate with the rod 518 into and out of contact with the shaft stoppers 534. Bolts (not shown) to which the stoppers 534, 536 connect may respectively extend through the main shaft 504 and rod 518, permitting the stoppers 534, 536 to be tightened on the opposing surfaces of the main shaft 102 and the rod 518.

In the exemplary embodiment shown, the shaft stoppers 534 protrude from opposing outwardly facing surfaces. The stoppers 534 are disposed off-centerline, and lie above and slightly offset from the rod 518 as best seen in FIG. 24A-C. Accordingly, the two shaft stoppers 534 on opposing sides of the shaft 504 extend parallel to, but offset from each other on opposing sides of the shaft centerline.

As best seen in FIG. 23A, the rod stoppers 536 extend from offset surfaces of the rod 518. Because the rod is rectangular, the rod stoppers 536 are offset from each by 90 degrees, the same offset between the optimum pressure receiving position and the least wind resistance position. In embodiments where the optimum pressure receiving position and the least wind resistance position is different than 90 degrees, then the rod stoppers 536 likewise may be offset at angles other than 90 degrees. Accordingly, as shown in the drawings, the protruding rod stoppers 536 extend in a direction transverse to the protruding shaft stoppers 534 and in a direction transverse to each other. Although described as having rectangular cross-sections, in other embodiments, the rods 518 and shaft 504 have other cross-sections, including round, for example,

FIGS. 23A-C and 24A-C show the rotation of a blade system 514 from the least wind resistance position to the optimum pressure receiving position and the role of the stopper system 232. Referring first to FIGS. 23A and 24A, the blade 516 lies in the least wind resistant position. One of the rod stoppers 536A interfaces with one of the shaft stoppers 534A. Because of this, the blade system 514 is at its limit or rotation in one direction. It can rotate only in the other direction. Because the wind is directed toward the trailing end of the blade 516, and because the blade system 514 includes blades 516 offset from each other by 90 degrees, the wind is also directed against a complete side of one of the blades 516. Accordingly, due to the offset nature of the rod 518 in the blade 516, the torque force on the blade 516 in the optimum pressure receiving turns the blade system 514 about the rod axis unless the motion is limited by the stopper system 532.

FIGS. 23B and 24B show the blade system 514 half-way through the rotation range between the optimum pressure receiving position and the least wind resistance position. FIGS. 23C and 24C show the blade 516 having arrived at the optimum pressure receiving position. Accordingly, the blade 516 is vertical, designed to receive the most pressure from a horizontal blowing wind. As shown in these figures, when in the optimum pressure receiving position, the rod stopper 536B engages the shaft stopper 534B, while the other rod stopper 536A and the other shaft stopper 534A are not engaged. The engaged rod and shaft stoppers prevent over-rotation of the blade 516, while the wind force holds the blade in the optimum pressure receiving position. As shown in FIG. 24C, the opposing blade 516 of the blade system 514 is now in the least wind resistance position. Positioned this way, the airfoil shape reduces drag, increasing efficiency.

It is contemplated that the stoppers are adjustable and may be used to adjust the range of rotation. For example, the stoppers may be removed and replaced with alternative stoppers having different width, such as a different diameter to adjust the range of rotation of the blades. Alternatively, the stoppers may be disposed in alternative locations. Thus, the stoppers may be adjusted to provide a rotation range within any desired range.

Because of the shape and arrangement of the blade system 514, with the blades offset from each other by 90 degrees, and because the blades 516 are offset or are not symmetrically disposed about the rods 518, the blades 516 are configured to rest at a 45 degree angle in a zero-wind condition. Said another way, in a zero-wind condition, the force of gravity pulls the blades 516 to a state of equilibrium in a position that is neither the pressure receiving position nor the least wind resistance position. FIG. 24B, but in a zero wind condition, shows the positioning where the blades would rest Because of the weight distribution and blade arrangement, any slight wind that begins to flow, regardless of the flow direction, will apply a wind force against the blades 516 and begin to affect the fluid turbine. This means that regardless of wind direction, wind will blow against a blade surface of a turbine to begin generating energy.

Some embodiments of the blades 516 include winglets as described above, while others are free of winglets. Yet other embodiments include winglets on both the inner and outer blade ends. Furthermore, the winglets may be airfoil shaped or alternatively, may be flat or rectangular winglets that cooperate with the blade to provide increased efficiency and responsiveness to fluid forces.

While some of the embodiments discussed herein are discussed relative to wind-driven systems, it is contemplated that any of these may be used as fluid mill or fluid-driven systems, utilizing either a flowing gas, such as air, or a flowing liquid. For example, one contemplated use of the system disclosed herein includes submerging the fluid mill into a flowing liquid, such as water In this aspect, the fluid drives the mill and the blades pivot as described above between the optimum pressure receiving position and the least wind resistance position.

Although only a few exemplary embodiments have been described in detail above, those skilled in the art will readily appreciate that many modifications are possible in the exemplary embodiments without materially departing from the novel teachings and advantages of this disclosure. Accordingly, all such modifications and alternatives are intended to be included within the scope of the invention as defined in the following claims. Those skilled in the art should also realize that such modifications and equivalent constructions or methods do not depart from the spirit and scope of the present disclosure, and that they may make various changes, substitutions, and alterations herein without departing from the spirit and scope of the present disclosure. It is understood that all spatial references, such as “horizontal,” “vertical,” “top,” “upper,” “lower,” “bottom,” “left,” and “right,” are for illustrative purposes only and can be varied within the scope of the disclosure.

We claim:

1. A fluid-driven turbine comprising:
a main driving shaft defining a shaft axis; and
a plurality of blade sets symmetrically disposed about the main driving shaft, each of the plurality of blade sets comprising:
a rod extending radially from the main driving shaft in a direction transverse to the shaft axis, the rod defining a rod axis,
a fluid-tiltable blade connected to the rod and extending along the direction of the rod axis, the fluid tiltable blade having an airfoil shape in cross-section with a leading edge, a trailing edge, and a maximum thickness, the blade, due to its asymmetrical design, is divided into first and second moment-inducing sections located on opposite sides of the rod with the first moment-inducing section being greater in area than the second moment-inducing section, the blade being rotatable about the rod axis between an optimum pressure-receiving position and a least fluid-resistance position for receiving fluid energy from variable directions, and
an adjustable stopper system limiting rotation of the blade about the rod axis to a rotation range between the optimum pressure-receiving position and a least fluid-resistance position.

2. The fluid-driven turbine of claim 1, wherein the stopper system comprises a first stopper portion fixed to and protruding from the rod and a second stopper portion fixed to and protruding from the main driving shaft, wherein during rotation of the rod, the first stopper portion contacts the second stopper portion to limit the rotation of the fluid-tiltable blade about the rod axis.

3. The fluid-driven turbine of claim 1, wherein the airfoil shaped blade is disposed so that the rod axis extends through the area of maximum thickness.

4. The fluid-driven turbine of claim 1, wherein the rod extends from opposing sides of the shaft and carries a blade on each of the opposing sides of the shaft, the blades being fixed to the rod and the rod being rotatable relative to the main shaft.

5. The fluid-driven turbine of claim 4, wherein the stopper system comprises:
a first stopper portion fixed to and protruding from the rod at a first side of the main drive shaft;
a second stopper portion fixed to and protruding from the main drive shaft, wherein during rotation of the rod, the first stopper portion contacts the second stopper portion to limit the rotation of the rod and the fluid-tiltable blade in a first direction;
a third stopper portion fixed to and protruding from the rod at a second side of the main drive shaft opposing the first side of the main drive shaft; and
a fourth stopper portion fixed to and protruding from the main drive shaft, wherein during rotation of the rod, the third stopper portion contacts the fourth stopper portion to limit the rotation of the rod and the fluid-tiltable blade in a second direction.

5. The fluid-driven turbine of claim 5, wherein the first and third stopper portions are disposed to extend transverse to each other.

6. The fluid-driven turbine of claim 1, wherein each blade includes a single winglet disposed on the inner ends of the blades.

7. The fluid-driven turbine of claim 1, wherein each blade is a cantilevered blade supported only by the main driving shaft.

8. The fluid-driven turbine of claim 1, wherein the blades have a relatively constant width.

9. The fluid-driven turbine of claim 1, wherein the blades are shaped and arranged to have a resting angle of 45 degrees in a zero fluid-flow condition.

10. A fluid-driven turbine comprising:
a main driving shaft defining a shaft axis; and
a plurality of blade sets symmetrically disposed about the main driving shaft, each of the plurality of blade sets comprising:
a blade set frame extending radially from the main driving shaft in a direction transverse to the shaft axis,
a rod defining a rod axis, the rod extending from the blade set frame in a direction substantially parallel to the shaft axis,
a fluid-tiltable blade connected to the rod and extending along the direction of the rod axis, the blade, due to asymmetrical design, is divided into first and second moment-inducing sections located on opposite sides of the rod with the first moment-inducing section being greater in area than the second moment-inducing section, the blade being rotatable about the rod axis between an optimum pressure-receiving position and a least fluid-resistance position for receiving fluid energy from variable directions, and
a stopper system comprising a stopper disposed on the blade set frame and protruding in the direction of the shaft axis from the blade set frame, the stopper being positioned to physically limit rotation of the blade about the rod axis.

11. The fluid-driven turbine of claim 10, wherein the plurality of blade sets each comprises:
a plurality of rods rod extending from the blade set frame, the plurality of rods being spaced in a line extending radially outwardly from the main driving shaft; and
a plurality of fluid-tiltable blades, each connected to a respective one of the plurality of rods,
wherein the stopper of the stopper system is disposed on the blade set frame between adjacent rods of the plurality of rods, along the line extending radially outwardly from the main driving shaft.

12. The fluid-driven turbine of claim 10, wherein the fluid tiltable blade includes a leading portion and a trailing portion, the leading portion having a length less than the trailing portion, and wherein the stopper is spaced from the rod along the blade set frame a distance greater than the length of the leading portion and less than the length of the trailing portion.

13. A fluid-driven turbine comprising:
a main driving shaft defining a shaft axis;
a rod extending transverse to the shaft axis on opposing first and second sides of the main driving shaft, the rod defining a rod axis;
a first fluid-tiltable blade fixed to the rod on the first side of the main driving shaft and extending along the direction of the rod axis;
a second fluid tiltable blade fixed to the rod on the second side of the main driving shaft and extending along the direction of the rod axis, the first and second tiltable blades being rotatable about the rod axis relative to the main driving shaft;
each of the first and second blades, due to asymmetrical design, are divided into first and second moment-inducing sections located on opposite sides of the rod with the first moment-inducing section being greater in area than the second moment-inducing section, the first and second blades being rotatable about the rod axis between an optimum pressure-receiving position and a least fluid-resistance position, the first blade being fixed to the rod at about a 90 degree angle relative to the second blade such that when the first blade is in the optimum pressure-receiving position, then the second blade is in the least fluid-resistance position, and when the second blade is in the optimum pressure-receiving position, then the first blade is in the least fluid-resistance position; and
an adjustable stopper system comprising a stopper fixed to and protruding from a first side of the main driving shaft, the first stopper being sized and positioned to cooperatively limit the rotation of the rod about its axis.

14. The fluid-driven turbine of claim 13, wherein the stopper system further comprises a second stopper fixed to and protruding from a second side of the main driving shaft, the second side opposing the first side of the main driving shaft, the first and second stoppers being sized and positioned to cooperatively limit the rotation of the rod about its axis.

15. The fluid-driven turbine of claim 14, comprising:
a third stopper fixed to and protruding from the rod at the first side of the main drive shaft; and
a fourth stopper fixed to and protruding from the rod at the second side of the main drive shaft, the third and fourth stoppers being disposed transverse to the first and second stoppers and being sized to engage the first and second stoppers respectively when the when the first blade is positioned in the optimum pressure-receiving position and the least fluid-resistance position.

16. The fluid-driven turbine of claim 15, wherein the rod has a rectangular cross-section, the third stopper being disposed to protrude from a first side of the rod and the fourth stopper being disposed to protrude from an adjacent side of the rod, such that the third and fourth stoppers protrude in directions transverse to each other.

17. The fluid-driven turbine of claim 13, wherein the first and second blades each comprise an outer surface and a winglet disposed on an inner end extending in a direction substantially normal to the outer surface.

18. The fluid-driven turbine of claim 13, wherein the first and second blades have a symmetrical airfoil shaped cross-section with a leading edge, a trailing edge, and a maximum thickness, the first and second blades being positioned relative to the rod axis such that the rod axis extends along the area of maximum thickness.

19. The fluid-driven turbine of claim 13, wherein each blade includes a single winglet disposed on the inner end of each blade.
